(19) United States
(12) Patent Application Publication
(10) Pub. No.: US 2009/0188435 A1
(43) Pub. Date: Jul. 30, 2009

(54) APPARATUS AND METHODS FOR SECURING PET DOORS

(76) Inventor: Seymour B. Hale, JR., Canon City, CO (US)

Correspondence Address: HOLLAND & HART, LLP, P.O BOX 8749, DENVER, CO, 80201, US

(21) Appl. No.: 12/359,990

(22) Filed: Jan. 26, 2009

Related U.S. Application Data
(60) Provisional application No. 61/062,527, filed on Jan. 25, 2008.

(51) Int. Cl. A01K 15/04; G08B 13/18; E04H 9/16; A01K 1/035

(52) U.S. Cl. 119/484; 340/556; 52/101

(57) ABSTRACT

There are disclosed electronic and barrier systems for a pet door. In an embodiment, an electronic monitoring system includes sensors and a control module set to recognize animals having different personalities trying to access the pet door. An alarm is in connection with the control module for actuation based on personality of the animal. In one embodiment, a security barrier component allows a dog access to the pet door and prevent a human from accessing the pet door. The barrier component requires the dog to turn from a side portion into the pet door to prevent a human from accessing the pet door. In another embodiment, a device for limiting access through a pet door includes a tunnel formed between a top surface and sidewalls sized for allowing a small pet, while preventing a larger animal, from passage through the pet door. Other embodiments are also disclosed.

### REFERENCE TO PENDING PRIOR PATENT APPLICATION

This application claims the benefit under 35 U.S.C. 119 (e) of U.S. Provisional Patent Application No. 61/062,527, filed Jan. 25, 2008 by Seymour B. Hale Jr. for “APPARATUS AND METHODS FOR SECURING PET DOORS,” which patent application is hereby incorporated herein by reference.

### BACKGROUND

Generally, pet doors allow ingress and egress of a living space for a domestic animal without requiring an owner to open and close a door. However, many different types of pet doors either allow other animals to enter the living space or require elaborate sensors. Entry by other animals is usually at least inconvenient and, at times, may be very dangerous. Elaborate sensor identification devices may require that a pet wear a transceiver on a collar, which may be dangerous for an animal and unnecessary due to “chipping” devices for pet identification. Furthermore, elaborate sensor identification devices may not function correctly at all times.

### SUMMARY OF THE INVENTION

In an embodiment, there is provided an electronic monitoring system for a pet door, the electronic monitoring system comprising sensors having motion detectors including light beam emitters and corresponding light beam detectors; a control module in operable connection with the sensors, the control module and the sensors set to determine different animals trying to access the pet door; and an alarm in connection with the control module, the alarm configured for actuation based on operation of the sensors related to personality of the animal recognized by the control module and the sensors.

In another embodiment, there is provided an electronic monitoring system for a pet door, comprising sensors having motion detectors and beams, set to recognize animals having different personalities attempting to access the pet door, wherein the sensors include two emitter-detector housings providing optical emitters and optical sensors, and an optical signal provided by the emitters is reflected by a corresponding one of reflectors; a control module in operable connection with emitter-detector housings, the module containing timers for controlling when an alarm siren is actuated in response to the optical pathways monitored by emitter-detector housings; and an audible alarm in operable connection with the control module.

In yet another embodiment, there is provided a security barrier component to allow a dog access to the pet door and prevent a human from accessing the pet door, the security barrier component comprising a side portion having an opening to allow entry of the dog; a back portion having an opening sized for communication with a pet door; and a front portion closed to prevent entry and require the dog to turn from the side portion into the pet door through the back portion, and the front portion and the back portion have a width sized to allow the dog to pass therethrough while preventing the human from accessing the pet door to pass therethrough.

In still another embodiment there is provided a device for limiting access through a pet door, the device comprising a top surface and two sidewalls extending downwardly from the top surface; at least one of the top surface and the sidewalls configured for attachment to a pet door; and a tunnel formed between the top surface and the sidewalls sized for allowing a small pet, and preventing a larger animal, from passage through the pet door.

Other embodiments are also disclosed

### BRIEF DESCRIPTION OF THE DRAWINGS

Illustrative embodiments of the invention are illustrated in the drawings, in which:

FIG. 1 illustrates an exemplary view of a pet door having an electronic monitoring system;

FIG. 2 illustrates portions of two emitter-detector housings of the electronic monitoring system within the pet door as shown in FIG. 1;

FIG. 3 illustrates an enlarged view of a portion of one of the emitter-detector housings as shown in FIG. 2;

FIG. 4 illustrates a housing, with an audible alarm, which is part of the electronic monitoring system of FIG. 1;

FIG. 5 illustrates another view of the pet door shown in FIG. 1 in which reflectors are shown mounted in opposition to the two emitter-detector housings;

FIG. 6 illustrates one of the two emitter-detector housings of the electronic monitoring system within the pet door as shown in FIG. 2;

FIGS. 7A, 7B, 7C and 7D illustrate a barrier system used in conjunction with a pet door, and each of the barrier system and the pet door include sensors forming an electronic monitoring system;

FIG. 8 illustrates a barrier configured to allow ingress and egress of an animal, but not a human, through a pet door;

FIG. 9 illustrates a configuration of pet door within a typical door or wall portion;

FIG. 10 illustrates the configuration of the pet door of FIG. 9 together with a box for restricting access with a lower height than the pet door; and

FIG. 11 illustrates a top plan view of the door or wall with the pet door mounted thereto and the box positioned to allow small animals and restrict large animals through the pet door.

### DETAILED DESCRIPTION

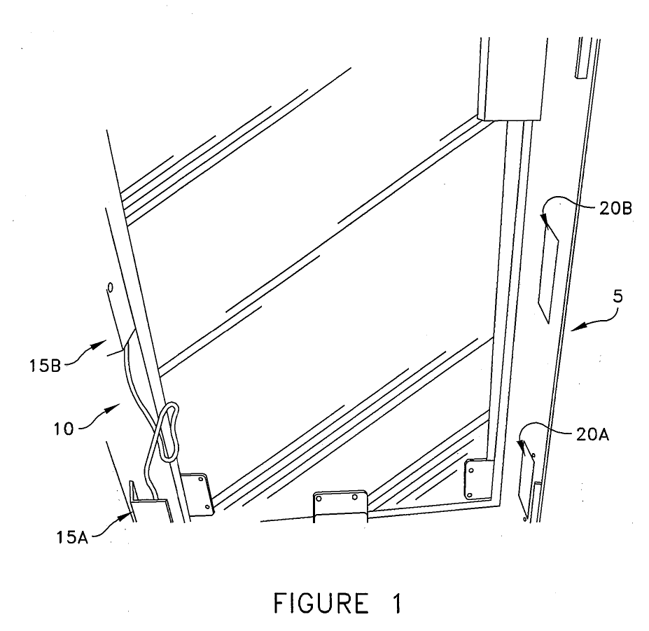

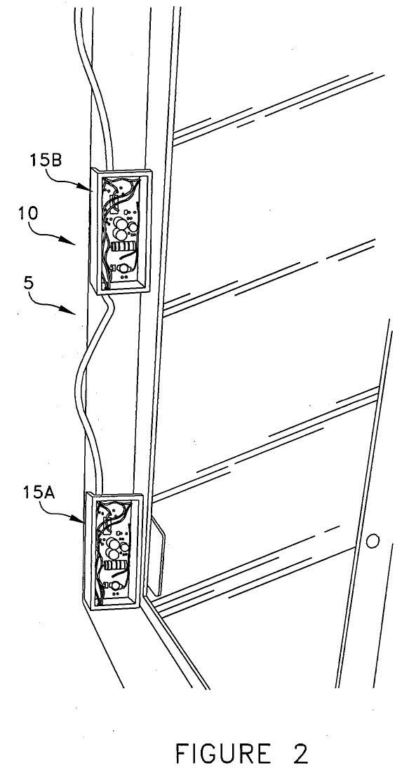

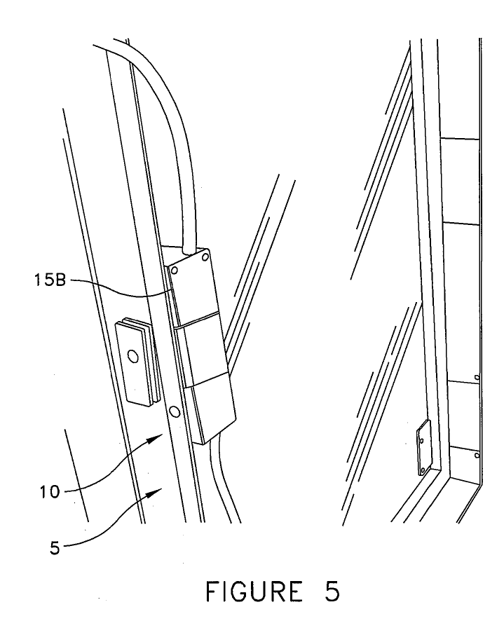

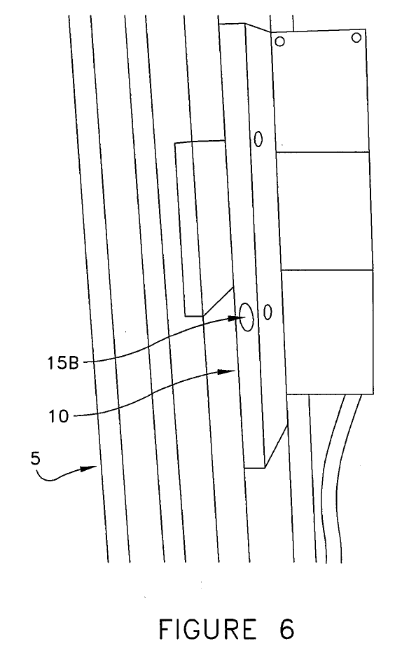

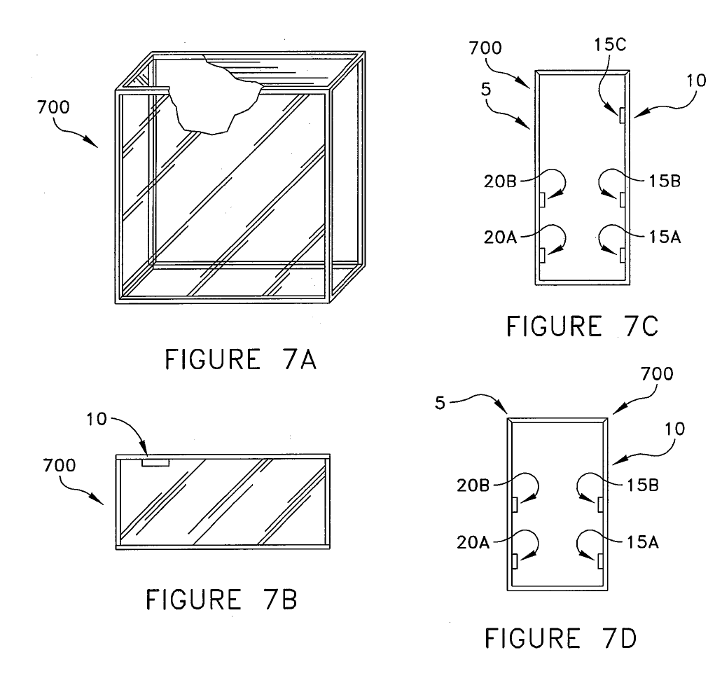

Referring to FIGS. 1-6 and 7C and 7D, there is shown a view of a pet door 5 having an electronic monitoring system 10. In various embodiments, electronic monitoring system 10 may include sensors 15A, 15B, and 15C (see FIG. 7D), which may include motion detectors and beams, set to recognize different animals that might try to access pet door 5.

In an embodiment, electronic monitoring system 10 is positioned within a pet door, such as a Hale Pet Door (FIG. 1) or within a specially constructed dog house (FIG. 7A).

One sensor 15A may be set to recognize a particular sized animal, such as a cat or raccoon, and emit a loud siren or odor release, etc., depending on the particular type of animal. This electronic monitoring system 10 may be configured to recognize a dog and shut down or prevent operation of the alarm system. This electronic monitoring system 10 may be mounted in pet door 5 or a dog house 700 (FIG. 7A).

In one embodiment, electronic monitoring system 10 includes two or three emitter-detector housings 15A, 15B and 15C. Each one of the housings may be similar or different in size, and may be sized about two inches wide 3 inches long and one inch deep. In some embodiments, electronic monitoring system 10 may be powered by batteries or an alternating current (AC) adaptor.

For example, FIGS. 1-7D electronic monitoring system 10 may be configured as a cat (or small animal) deterrent alarm. Two emitter-detector housings 15A and 15B function as optical emitters and optical sensors, and the optical signal provided by the emitters is reflected by a corresponding one of reflectors 20A and 20B. In one embodiment, reflectors 20A and 20B may include Scotchlite brand reflective tape. A control module 30 is in operable connection with emitter-detector housings 15A and 15B. Module 30 may contain timers for controlling when an alarm siren is actuated in response to the optical pathways monitored by emitter-detector housings 15A and 15B. A battery holder 35 (or battery pack 35) may be provided to power electronic monitoring system 10. The audible alarm may include a piezoelectric siren noise maker in connection with control module 30.

Emitter-detector housings 15A and 15B may be fastened or held onto pet door 5 in various ways. For example, emitter-detector housings 15A and 15B may each be held with a foam-type sticky pad or held with one or more magnets. By using magnets, the parts may be slid up and down on the frame of pet door 5.

Control module 30 and battery pack 35 may be mounted onto an upper inside surface of the frame. A screw may be used to attach one or more components, including the siren to the upper right corner of the frame. Wires may be used to connect components. These wires may be configured with excess length so as to allow desired reconfiguration of the components to various positions on a frame or to larger frames.

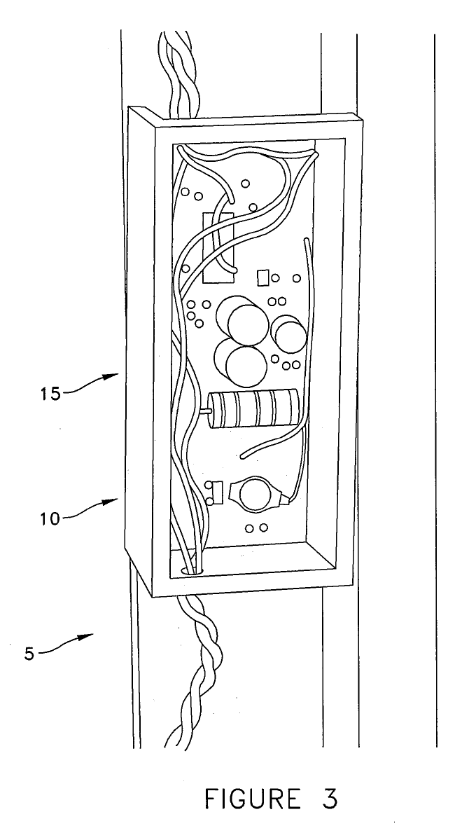

FIG. 3 illustrates a close-up view of emitter-detector housing 15A (or 15B or 15C.) Within housing 15A (or 15B or 15C), there may be provided an LED corresponding to the emitter portion and a photodiode corresponding to the sensor or detector portion.

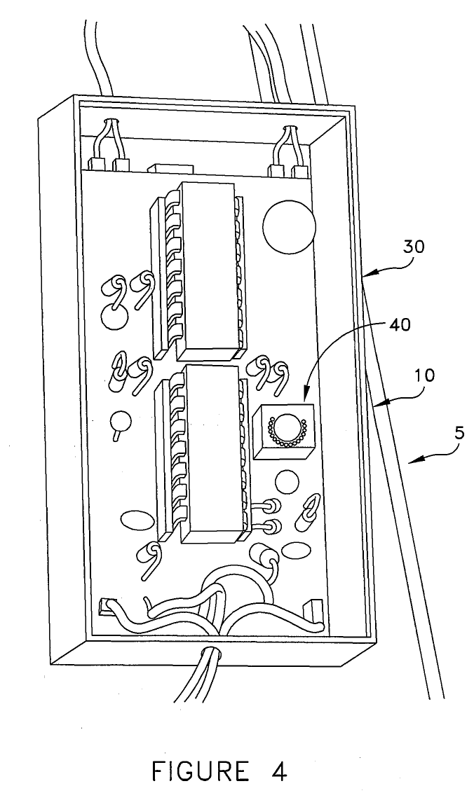

FIG. 4 illustrates a close-up view of alarm control module 30. A potential switch 40 (shown in blue) may be provided for adjusting the delay time of the lower beam corresponding to housing 15A and reflector 20A. Control module 30 may include several timers. One of the timers may control the time between the breaking of the lower beam and the activation of an alarm siren. A second timer may limit the time the siren can run. For example, this may be for about 5 seconds. A third timer may disable the siren for about 3 seconds after an upper beam between housing 15B and reflector 20A is broken. In one embodiment, only the first time is adjustable using potential switch 40.

Operation of electronic monitoring system may proceed as follows. In standby mode, the siren is active. If an object breaks the lower beam, a delay timer is started. If the beam remains broken after the delay time has elapsed, the siren will emit an audible alarm. If continuity of the lower beam is reestablished, the siren is immediately turned off. If the upper beam is broken without breaking the lower beam, nothing will happen. If the upper beam is broken any time the lower beam has been broken, the siren will be disabled for about 3 seconds. This configuration is based on the differing personalities between dogs and those of cats and other small animals. For example, a dog will generally enter a pet door in a confident manner that quickly breaks two or more monitoring beams. In contrast, a cat or other small animal will generally be much more timid and enter with its head low so as to break only one beam.

In this mode, the siren is turned on if only the lower beam is broken after a delay time. An animal pushing against the lower part of the pet door flap will be greeted with a loud sound after the adjustable time delay. An animal which might break the lower beam followed by the upper beam will have three seconds to pass through the door without the siren being activated. The 3 second time will disable the lower beam in the event that a foot or tail breaks the lower beam as the larger animal passes through the door after the upper beam has been broken.

In an embodiment, the logic of electronic monitoring system 10 may be reversed to allow ingress and egress of a cat, but not a dog. For example, an alarm will activate when more than just a lower beam is broken.

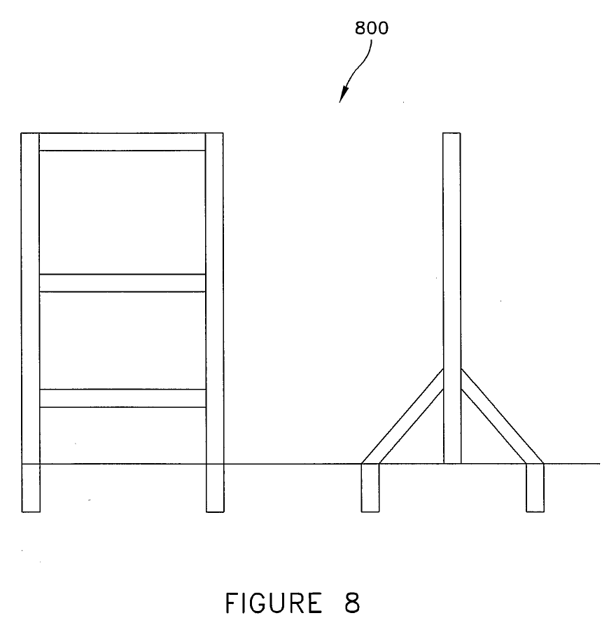

Looking now at FIGS. 7A-7D and 8, and in two exemplary embodiments, there are shown examples of a barrier system 700 and a set of security barrier components 800. Most dogs are able to maneuver well into side door 700 as shown in FIGS. 7A-7D or between barrier components 800. While an 80 pound dog can easily maneuver through either of these impediments, it is very difficult, if not impossible, for a human to enter through a properly placed side door 700 or barrier component system 700 due to the bending configuration of the knees in the opposite direction as the remaining portion of the body. As such, an adult or a child will not be able to enter through one of these impediments.

Looking at FIG. 800, there is shown security barrier components 800 of different sizes set outside of a pet door (not shown.) Barrier components 800 may be configured to allow a dog access to the pet door but prevent a human from accessing the pet door. These barrier components 800 could also be used with certain size pet doors to keep an infant from using the pet door. A similar barrier may be attached to an actual door to allow a pet to use the pet door but keep a person from using the pet door or reaching in and unlocking the door. Actual shapes and number of barrier components 800, which may include a singular barrier component 800, may be determined by the type of animal that would be using the pet door and the location of the pet door. In addition, the width of the barrier extending away from the dwelling may be initially configured in a wider configuration for training the pet, and may be subsequently narrowed to provide enhanced security.

Barrier component 800 may be covered, if desired, by a dog house or a specially constructed planter. The dog house may include various shapes built to go over security barrier component 800. The dog house may include a break away roof that can be set with an alarm. The dog house may be attached to the ground and the roof may be designed for removal before the dog house could be moved. A person trying to gain access would still have the dog house and the barrier to overcome after an audible siren is activated from disturbing the dog house.

In an embodiment, the barrier component 700 or 800 and/or the covering may be removable for training a timid dog. Optionally, the barrier component 700 or 800 and/or the covering may be anchored to concrete.

In another embodiment, a siren placed in a box, such as a dog house or a planter, may include a siren configured for frightening away a pest, e.g., a raccoon or a rodent.

The devices described hereinabove may be placed in front of a pet door within or adjacent to a full-sized door, through a wall, or near other types of openings.

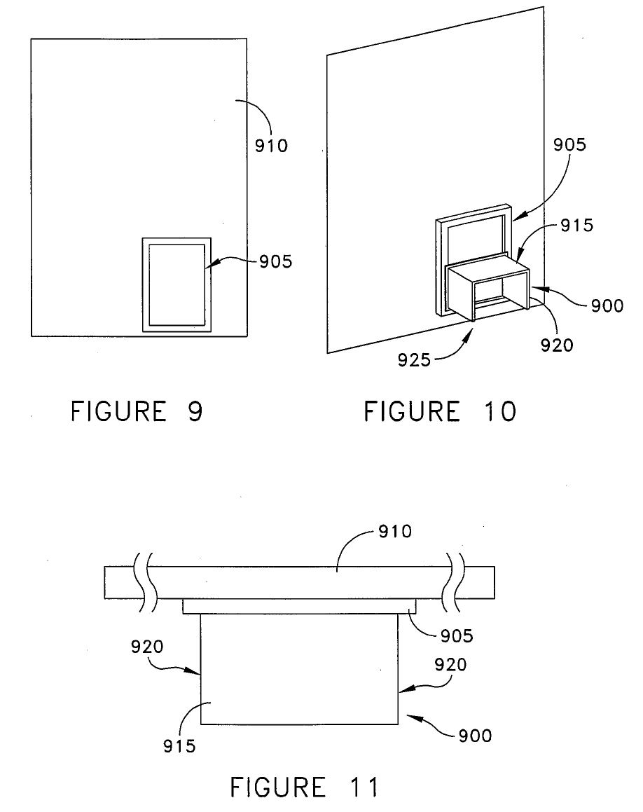

In another embodiment, and as best illustrated in FIGS. 9-11, a box 900 may be mounted on a surface of a pet door 905, which in turn may be mounted to another structure 910 (such as a door or a wall.) This box 900 may be closed on a top portion 915 and each of sides 920 and open at bottom 925. Box 900 is placed high enough for cats to get thereunder and through pet door 900, but low enough that a dog cannot reach pet door 900. People often desire to place a cat litter box and food in an area with access for cats with a small pet door. A dog may want to get to the food and litter box. Sometimes the dog squeezes through the pet door. Other times, the dog tears up the pet door. In such instances, significant damage may be caused. Box 900 prevents this type of expensive damage. Box 900 may be constructed of very durable plastic, which is light weight but strong and shatter resistant.

In one embodiment, box 900 may be constructed as a device that can be used on an interior door or wall. In another embodiment, box 900 may be constructed as a device that can be used on an exterior door or wall of a home or office. In other embodiments, box 900 may be constructed for use on these or other applications with a pet door. Box 900 may also be used for security aspects on a pet door as it would be harder for someone to reach in and unlock the door through the pet door.

What is claimed is:

1. An electronic monitoring system for a pet door, the electronic monitoring system comprising:
sensors having motion detectors including light beam emitters and corresponding light beam detectors;
a control module in operable connection with the sensors, the control module and the sensors set to determine different animals trying to access the pet door; and
an alarm in connection with the control module, the alarm configured for actuation based on operation of the sensors related to personality of the animal recognized by the control module and the sensors.

2. An electronic monitoring system for a pet door in accordance with claim 1, wherein the electronic monitoring system is positioned within one of a pet door and a dog house.

3. An electronic monitoring system for a pet door in accordance with claim 1, wherein the sensor is set to recognize an animal having a particular personality and, based on recognition of the animal having the particular personality emit an odor.

4. An electronic monitoring system for a pet door in accordance with claim 1, wherein the electronic monitoring system is configured to recognize a dog and shut down operation of the alarm system so as to allow the dog to enter the pet door.

5. An electronic monitoring system for a pet door in accordance with claim 1, wherein the electronic monitoring system is mounted in one of pet door and a dog house.

6. An electronic monitoring system for a pet door in accordance with claim 1, wherein the electronic monitoring system includes at least two housings for the light beam emitters and the corresponding light beam detectors.

7. An electronic monitoring system for a pet door in accordance with claim 6, wherein each one of the housings is similar in size to one another.

8. An electronic monitoring system for a pet door in accordance with claim 6, wherein each one of the housings is different in size to one another.

9. An electronic monitoring system for a pet door in accordance with claim 6, wherein each one of the housings is sized about two inches wide 3 inches long and one inch deep.

10. An electronic monitoring system for a pet door in accordance with claim 1, wherein the electronic monitoring system is powered by one or batteries and an alternating current (AC) adaptor.

11. An electronic monitoring system for a pet door in accordance with claim 1, wherein the electronic monitoring system is configured as a cat and small animal deterrent alarm.

12. An electronic monitoring system for a pet door, comprising:
sensors having motion detectors and beams, set to recognize animals having different personalities attempting to access the pet door, wherein the sensors include two emitter-detector housings providing optical emitters and optical sensors, and an optical signal provided by the emitters is reflected by a corresponding one of reflectors;
a control module in operable connection with emitter-detector housings, the module containing timers for controlling when an alarm siren is actuated in response to the optical pathways monitored by emitter-detector housings; and
an audible alarm in operable connection with the control module.

13. An electronic monitoring system for a pet door in accordance with claim 12, wherein the pet door includes a battery holder provided to power the sensors, control module, and the audible alarm of the electronic monitoring system.

14. An electronic monitoring system for a pet door in accordance with claim 13, wherein the control module and the battery holder are mounted onto an upper inside surface of a frame of the pet door.

15. An electronic monitoring system for a pet door in accordance with claim 12, wherein the emitter-detector housings are positioned onto pet door with at least one of a foam-type sticky pad and a magnet.

16. An electronic monitoring system for a pet door in accordance with claim 15, wherein the magnets are configured to allow the housings to be selectively positioned up and down on a frame of the pet door.

17. An electronic monitoring system for a pet door in accordance with claim 12, wherein the emitter includes an LED for the optical emitter and a photodiode for the optical sensor.

18. An electronic monitoring system for a pet door in accordance with claim 12, wherein the control module includes a switch for adjusting the delay time of a lower beam of the two emitter-detector housings providing optical emitters and optical sensors.

19. An electronic monitoring system for a pet door in accordance with claim 12, wherein the sensors include three emitter-detector housings providing optical emitters and optical sensors.

20. An electronic monitoring system for a pet door in accordance with claim 12, wherein the two emitter-detector housings are disposed in relatively horizontal positions with one set of the emitter-detector housings forming an upper beam and one set of the emitter-detector housings forming a lower beam.

21. An electronic monitoring system for a pet door in accordance with claim 12, wherein the control module includes several timers, including a first timer to determine the time between the breaking of the lower beam for activation of an alarm siren, a second timer to limit the time the siren can run, and a third timer to disable the siren for about 3 seconds after an upper beam is broken.

22. An electronic monitoring system for a pet door in accordance with claim 12, wherein logic of the electronic monitoring system is selected to allow ingress and egress of a cat, but not a dog.

23. A security barrier component to allow a dog access to the pet door and prevent a human from accessing the pet door, the security barrier component comprising:
a side portion having an opening to allow entry of the dog;
a back portion having an opening sized for communication with a pet door; and
a front portion closed to prevent entry and require the dog to turn from the side portion into the pet door through the back portion, and the front portion and the back portion have a width sized to allow the dog to pass therethrough while preventing the human from accessing the pet door to pass therethrough.

24. A security barrier in accordance with claim 23, further comprising a covering positionable over the side portion, the back portion, and the front portion.

25. A security barrier in accordance with claim 24, wherein the covering is a dog house.

26. A security barrier in accordance with claim 25, wherein the dog house includes a break away roof set with an alarm.

27. A security barrier in accordance with claim 25, wherein the dog house is attached to the ground and the roof may be designed for removal before the dog house could be moved such that a person trying to gain access would have the dog house and the barrier to overcome after an audible siren is activated from disturbing the dog house.

28. A security barrier in accordance with claim 24, wherein the covering is a planter.

29. A security barrier in accordance with claim 24, wherein one of at least a portion of the barrier and the covering is removable for training a timid dog.

30. A security barrier in accordance with claim 24, wherein one of the barrier component and the covering may be anchored to concrete.

31. A security barrier in accordance with claim 24, further comprising a siren placed in the covering, wherein the siren is configured for frightening away a pest.

32. A security barrier in accordance with claim 24, wherein the barrier is securely positionable in front of a pet door within a full-sized door.

33. A security barrier in accordance with claim 24, wherein the barrier is securely positionable in front of a pet door within a wall.

34. A device for limiting access through a pet door, the device comprising:
a top surface and two sidewalls extending downwardly from the top surface;
at least one of the top surface and the sidewalls configured for attachment to a pet door; and
a tunnel formed between the top surface and the sidewalls sized for allowing a small pet, and preventing a larger animal, from passage through the pet door.

35. A device for limiting access though a pet door according to claim 34, wherein the device is configured for use on an interior door.

36. A device for limiting access though a pet door according to claim 34, wherein the device is configured for use on an exterior door.

37. A device for limiting access though a pet door according to claim 34, wherein the device is configured for use on an interior wall.

38. A device for limiting access though a pet door according to claim 34, wherein the device is configured for use on an exterior wall.

39. A device for limiting access though a pet door according to claim 34, wherein the devices is configured for security aspects to prevent a person from reaching a door lock through the pet door.
